(19) United States
(12) Patent Application Publication
(10) Pub. No.: US 2012/0085036 A1
(43) Pub. Date: Apr. 12, 2012

(54) Rotating mechanism

(75) Inventors: Ryuhei Nishida, Kanagawa (JP); Atsushi Doi, Kanagawa (JP)

(73) Assignee: Nifco Inc., Kanagawa (JP)

(21) Appl. No.: 12/736,636

(22) PCT Filed: Apr. 23, 2009
(86) PCT No.: PCT/JP2009/058094

§ 371 Date: Dec. 21, 2010

(30) Foreign Application Priority Data
Apr. 24, 2008 (JP) 2008 113262

(51) Int. Cl. E05F 3/00

(52) U.S. Cl. 49/386

(57) ABSTRACT

A rotating mechanism includes a biasing device (4) and a damper device. When a movable body (2) is changed over from a first position to a second position and from the second position to the first position of a main body (1), the rotating mechanism operates to rotate the movable body (2) against a biasing force of the biasing device (4) up to midway of a changeover operation thereof, rotates the movable body (2) by the biasing force of the biasing device (4) after the midway, and brakes the movable body (2) by the damper device in a predetermined interval in which the movable body (2) is rotated by the biasing force. The movable body (2) includes an arm (21) integrally rotated. The damper device is a piston damper (3) which is rotatably and pivotally supported on the main body (1), connected directly or indirectly relative to the arm (21), and provided so that an extending/retracting direction thereof is changed over on the midway of the changeover operation of the movable body (2). The usability and the high quality of the rotating mechanism can be improved by providing braking of the damper device for the rotating mechanism in an optimal aspect.

### FIELD OF TECHNOLOGY

This invention relates to a rotating mechanism allowing especially one portion of a changeover operation to rotate by a biasing force of biasing means, in the rotating mechanisms changing over a movable body between a first position and a second position of a main body.

### BACKGROUND ART

As shown in FIGS. 10(a), 10(b), when a lid 42 is changed over between an open position and a closed position of a main body 41, the rotating mechanism, which rotates one portion of the changeover operation thereof by a biasing force of a torsion spring (turnover spring) 43, or operates to rotate one portion of the changeover operation against the biasing force, is well-known (for example, see Patent Document 1). More concretely, this rotating mechanism includes a total of four pins 44a, 44b projecting from both side walls of the lid 42 by two pieces on one side; guide grooves 46 provided on both sides of the main body 41 and including branch grooves 46a; the torsion spring 43 biasing the lid 42 in two directions; and a rotating plate 45 pivotally supported at axial portions 48 projecting from both sides of the main body 41 and also forming escape grooves 45a.

Here, the pins 44a, 44b fit into the guide grooves 46. Also, the escape groove 45a of the rotating plate 45 fits into a projecting end of the pin 44a. Also, in the torsion spring 43, one end side is locked in a locking portion 47 on a main body side, and the other end side is locked in the pin 44a. Then, as for the lid 42, in the closed position shown in FIG. 10(a), the pin 44b is positioned in an upper end of the guide groove 46, and the pin 44a is positioned in the branch groove 46a. Then, the lid 42 is retained in a state of being biased in a closed direction by the torsion spring 43. When the lid 42 is changed over to the open position, the lid 42 is operated to rotate in an open direction against the biasing force of the torsion spring 43. Thereby, the lid 42 rotates for a predetermined angle at a center of the pin 44b, and after the pin 44a returns to the guide groove 46 from the branch groove 46a, both pins 44a, 44b move to lower end side of the guide groove 46 as shown in FIG. 10(b). When the pin 44a enters into the guide groove 46 from the branch groove 46a, the torsion spring 43 biases the lid 42 in the open direction while the lid 42 is moving reversely.

Also, as for a conventional rotating mechanism, the rotating mechanism, including the biasing means and rotary-type damper means, rotating one portion of the changeover operation thereof by the biasing force of the biasing means, or operating to rotate one portion of the changeover operation against the biasing force, and braking one portion of the changeover operation by the damper means when the lid is changed over between the closed position and the open position of the main body, is well-known. As for a braking mechanism used for the above-mentioned rotating mechanism, the braking mechanism, in which the damper means allows the lid to open slowly when the lid is opened through a one-way clutch (one-way clutch apparatus), and not to operate when the lid is closed (for example, see Patent Document 2), is well-known.

### PRIOR ART DOCUMENTS

### Patent Documents

Patent Document 1: Japanese Unexamined Patent Publication No. 2001-336335
Patent Document 2: Japanese Unexamined Patent Publication No. 2005-67708
Patent Document 3: Japanese Unexamined Patent Publication No. 2008-240505

### DISCLOSURE OF THE INVENTION

### Problems to be Solved by the Invention

Among the above-mentioned respective rotating mechanisms, in the rotating mechanism of Patent Document 2, when the lid is moved from the closed position to the open position by the biasing force, the damper means brakes an opening speed of the lid through the one-way clutch, and conversely, when the lid is operated to rotate from the open position to the closed position against the biasing force, the lid can be operated without receiving the braking of the damper means. However, in this rotating mechanism, as for the braking mechanism, a braking force is provided either when the lid is rotated from the closed position to the open position, or when the lid is rotated from the open position to the closed position. In other words, in the rotating mechanism, as shown in Patent Document 1, if the lid is manually operated to rotate up to midway from the closed position, the lid rotates by the biasing force after the midway so as to be changed over to the open position, or the lid is manually operated to rotate up to the midway from the open position and rotates by the biasing force after the midway so as to be changed over to the closed position. In a conventional braking mechanism, braking only during a process of rotating the lid by the biasing force, or conversely, not receiving the braking only during a process of manually operating to rotate the lid, could not be possible.

Incidentally, with respect to the above-mentioned problems, the present applicants devised a rotating mechanism as follows (see Patent Document 3). Specifically, the rotating mechanism described in Patent Document 3 includes biasing means and damper means for braking, and when a movable body is changed over from a first position to a second position, or from the second position to the first position of the main body, the rotating mechanism operates to rotate the movable body against the biasing force of the above-mentioned biasing means up to midway of the changeover operation thereof, and rotates the movable body by the biasing force of the biasing means after the midway. Also, the rotating mechanism brakes the movable body by the damper means only in an interval in which the movable body is rotated by the biasing force. Objects of the present invention are to easily make the same operation as the rotating mechanism thereof feasible, reduce the cost, and expand in application.

### Means for Solving the Problems

In order to achieve the above-mentioned objects, in the present invention, if an embodiment is specified as a reference, a rotating mechanism includes biasing means (4) and damper means for braking. When a movable body (2) is changed over from a first position to a second position and from the second position to the first position of a main body (1), the rotating mechanism operates to rotate the movable body (2) against a biasing force of the above-mentioned biasing means up to midway of a changeover operation thereof, rotates the movable body (2) by the biasing force of the above-mentioned biasing means after the midway, and brakes the movable body (2) by the above-mentioned damper means in a predetermined interval in which the movable body (2) is rotated by the biasing force. The rotating mechanism is characterized in that the above-mentioned movable body (2) includes an arm (21) integrally rotated, and also that the above-mentioned damper means is a piston damper (3, 3A, 3B) which is rotatably and pivotally supported on the above-mentioned main body (1), connected directly or indirectly relative to the above-mentioned arm (21), and provided so that an extending/retracting direction thereof of the above-mentioned movable body (2) is changed over on the midway of the changeover operation.

In the above-mentioned present invention, the movable body includes a lid, door, cover, and the like. The main body includes a box, various types of storage portions or apparatuses. As for the first position and the second position of the main body, for example, if the movable body is the lid as shown in the embodiment, one is an open position, and the other is a closed position. The damper means for braking is the piston damper. As for this damper means, for example, an existing product as disclosed in, for example, Japanese Utility Model Publication No. H07-7638, Japanese Unexamined Patent Publication No. H08-277873, and Japanese Unexamined Patent Publication No. 2006-90502, can be used. In that case, the piston damper of a first embodiment is a type in which a braking force acts when a piston rod extends; the piston damper of a second embodiment is a type in which the braking force acts when the piston rod retracts; and the piston damper of a third embodiment is a type (claim 7) in which the piston rod is biased in a direction of extending by a coil spring which is the biasing means. Also, it is essential for each piston damper to be provided so as to be rotatably and pivotally supported on a corresponding portion of the main body, connected relative to the arm provided in the movable body and integrally rotating, i.e. connected directly or indirectly to the arm, and provided so that the extending/retracting direction thereof of the movable body is changed over on the midway of the changeover operation.

The above-mentioned present invention is preferably embodied as claims 2 to 7.

Specifically,

(A) the present invention has any of structures that the above-mentioned arm and the above-mentioned piston damper are rotatably connected (claim 2), or that the above-mentioned arm and the above-mentioned piston damper are connected through a connecting member rotatably and pivotally supported on the above-mentioned main body (claim 3).

(B) A connecting portion between the above-mentioned arm and the above-mentioned piston damper has a structure (claim 4) of traversing a straight line connecting each rotational center of the movable body and the above-mentioned piston damper when the above-mentioned movable body is changed over from the first position to the second position and from the second position to the first position of the above-mentioned main body.

(C) The above-mentioned piston damper has a structure (claim 5) in which the braking force acts on only one of an extending direction or a retracting direction.

(D) The above-mentioned biasing means has a structure (claim 6) comprising a turnover spring which is sandwiched between the above-mentioned main body and the above-mentioned movable body.

(E) The above-mentioned biasing means has a structure (claim 7) comprising the coil spring housed inside a cylinder of the above-mentioned piston damper.

### Effect of the Invention

In the present invention of claim 1, the rotating mechanism operates to rotate the movable body against the biasing force up to the midway from the first position toward the second position, and rotates the movable body by the biasing force from the midway up to the second position. Also, the rotating mechanism operates to rotate the movable body against the biasing force up to the midway from the second position toward the first position, and rotates the movable body by the biasing force from the midway up to the first position. Due to a simplified structure compared to the rotating mechanism described in Patent Document 3, the braking force by the piston damper is provided only in the predetermined interval in which the movable body is rotated by the biasing force, so that the quality of the rotating mechanism can be enhanced.

In the invention of claim 2, the rotating mechanism excels in simplification, since the arm on a movable body side and the piston damper are directly connected as shown in the first embodiment. On the other hand, in the invention of claim 3, if the arm on the movable body side and the piston damper are connected through the connecting member as shown in the second embodiment, a stroke (an extending/retracting amount) of the piston damper can be changed so that degrees of freedom of design can be expanded.

In the invention of claim 4, as shown in the first embodiment, if the connecting portion of the arm and the piston damper is made so as to directly traverse the straight line connecting each rotating center of the movable body and the piston damper, while using a one-way type which exerts the braking force only at a time of extending, the braking force can act both when the movable body is rotated by the biasing force from the midway to the first position, and when the movable body is rotated to the second position. On the other hand, the invention of claim 5 has significance in specifying in a confirmative fashion that the piston damper may be the one which can exert a braking action in only one of the extending direction or the retracting direction.

In the invention of claim 6, if the biasing means is the turnover spring, the turnover spring can arbitrarily change the biasing force, and excels in versatility. On the other hand, in the invention of claim 7, by using the piston damper in which the coil spring is embedded as the biasing means, the above-mentioned biasing action and braking action can be realized, so that the simplification can be undertaken further.

### BRIEF DESCRIPTION OF THE DRAWINGS

FIGS. 1(a), 1(b) are side views of both sides showing a storage apparatus in which a rotating mechanism of a first embodiment is applied in a closed position of a lid.

FIG. 2 shows a side view showing a state wherein the above-mentioned lid is operated to rotate up to midway.

FIG. 3 is a side view in a state wherein the above-mentioned lid is changed over to an open position by a biasing force.

FIG. 4 is a side view showing the other side face in the state of FIG. 3.

FIGS. 5(a), 5(b) are a front view and a plan view of the storage apparatus of FIGS. 1(a), 1(b) viewed from a front side.

FIGS. 6(a), 6(b) are side views of both sides showing a second embodiment corresponding to FIGS. 1(a), 1(b).

FIG. 7 is a side view showing a state wherein the lid in FIGS. 6(a), 6(b) is operated to rotate up to the midway.

FIG. 8 is a side view in a state wherein the lid in FIG. 7 is changed over to the open position by the biasing force.

FIGS. 9(a), 9(b) are side views of both sides showing a third embodiment corresponding to FIGS. 1(a), 1(b).

FIGS. 10(a), 10(b) are explanatory views showing the rotating mechanism of Patent Document 1.

### BEST MODES OF CARRYING OUT THE INVENTION

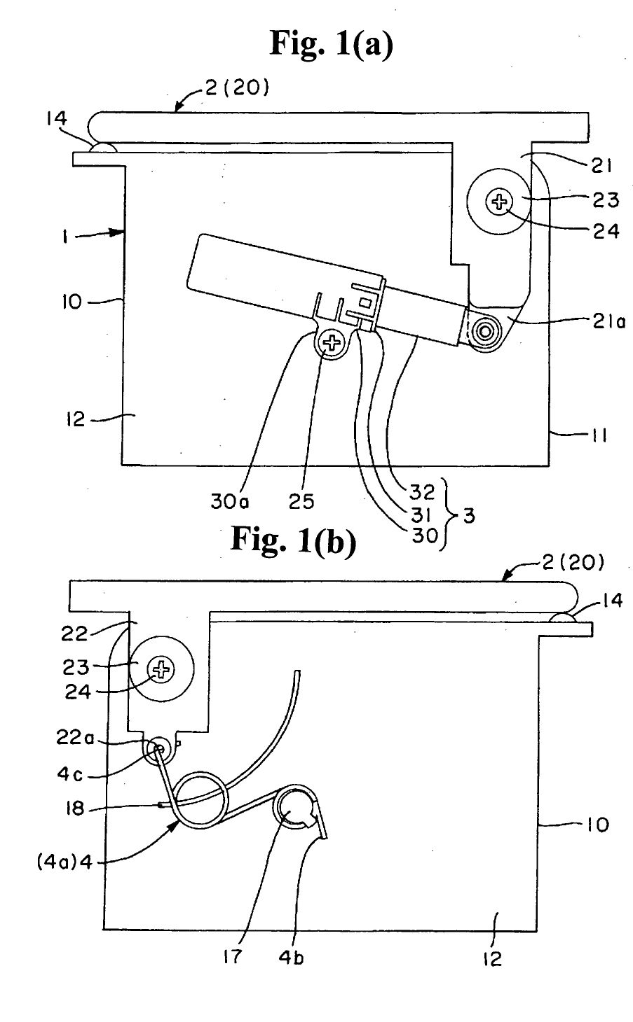

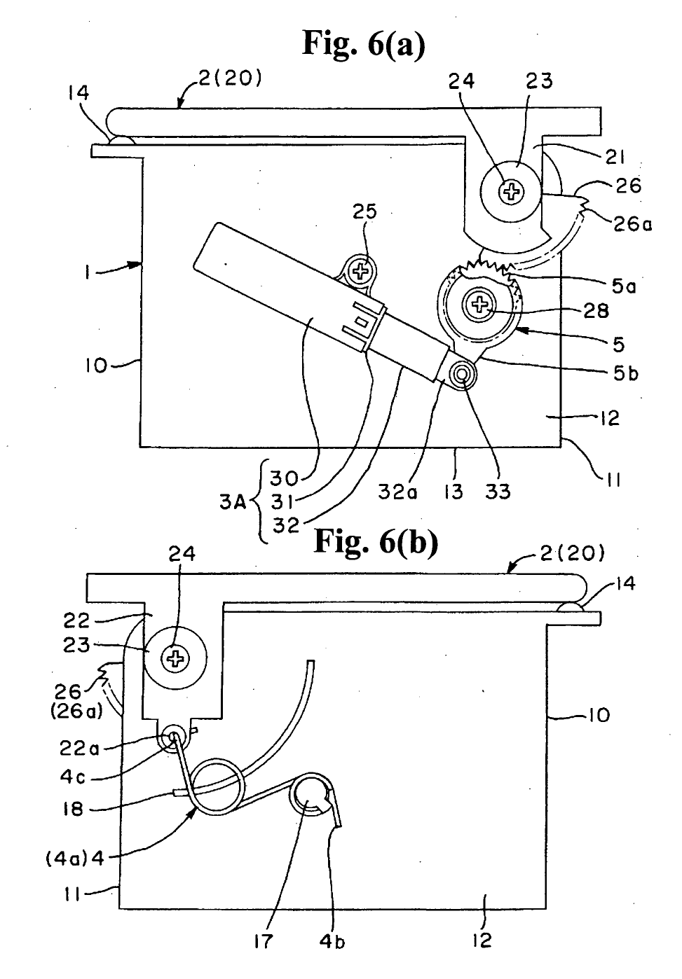

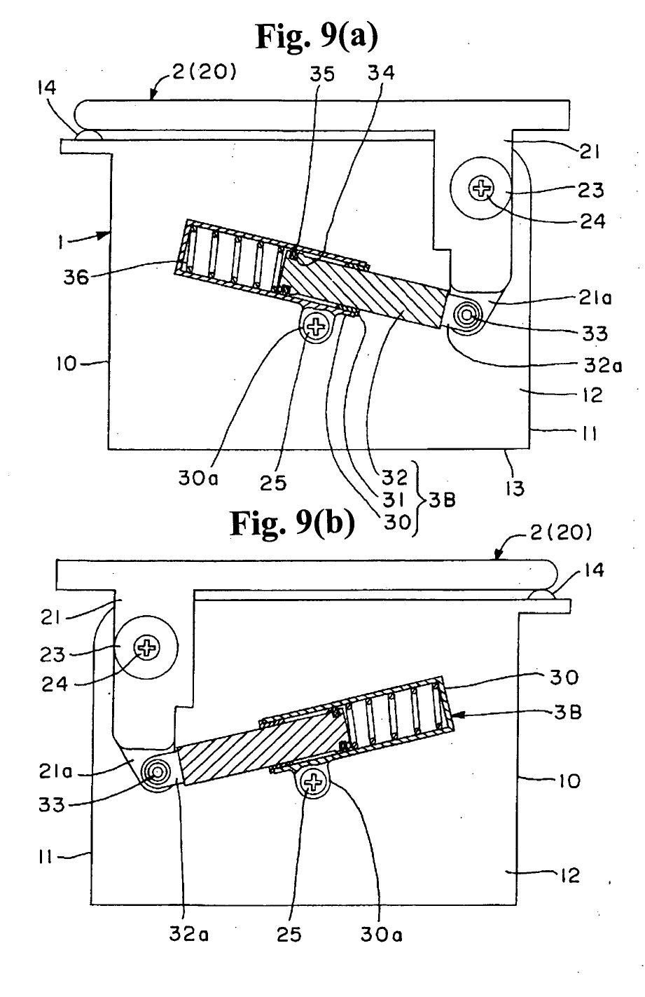

As for embodiments of the present invention, a first embodiment shown in FIGS. 1(a) to 5(b); a second embodiment shown in FIGS. 6(a) to 8; and a third embodiment shown in FIGS. 9(a), 9(b), will be explained. Incidentally, in each drawing, one portion will be omitted or simplified for convenience of the drawing. In the second embodiment and the third embodiment, the same symbols are assigned to the same members and portions in the first embodiment, and a part of overlapped descriptions is omitted. In the following explanation, an applicable apparatus, a rotating mechanism and the performance, modification of the second embodiment, and the modification of the third embodiment, will be described in detail in that order.

(Applicable Apparatus)

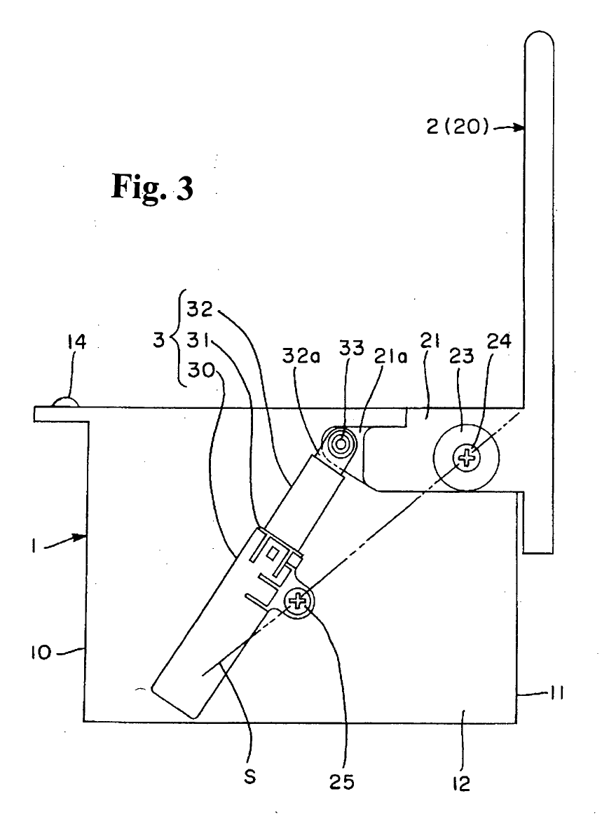

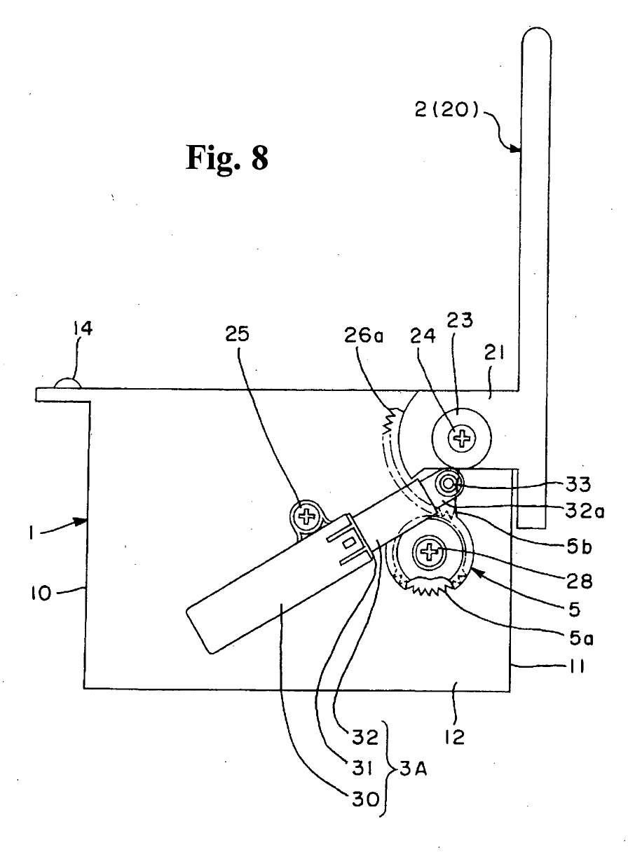

Each embodiment is an example in which the rotating mechanism of the present invention is applied to a storage apparatus. In this storage apparatus, a lid 2 can be changed over relative to a main body 1 by rotating a closed position (positions shown in FIGS. 1(a), 1(b), or FIGS. 6(a), 6(b), 9(a), 9(b)) blocking an opening portion on a main body side, and an open position (positions shown in FIG. 3 or FIG. 8) fully opening the opening portion on the main body side through the rotating mechanism of the present invention. Also, at the time of this changeover, the lid 2 is operated to rotate against a biasing force up to midway from the closed position toward the open position, and is rotated by the biasing force up to the open position from the midway. Also, the lid 2 is operated to rotate against the biasing force up to the midway from the open position toward the closed position, and is rotated by the biasing force up to the closed position from the midway.

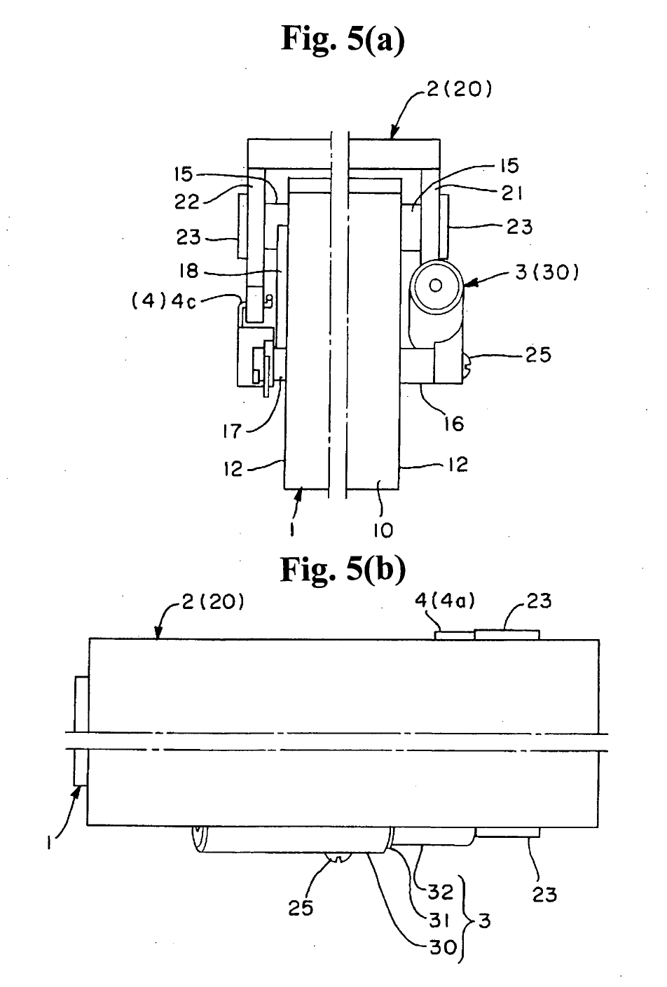

Here, as shown in FIGS. 1(a), 1(b) and FIGS. 5(a), 5(b), the main body 1 is formed in a box shape whose interior portion is surrounded by front and back walls 10, 11, both side walls 12, and a bottom wall 13, and includes an opening on an upper side. On the upper side of the front wall 10, an upper flange portion with a collar shape jutting forward is provided, and a buffer member 14 made of rubber and the like, which receives a corresponding portion of the lid 2, is additionally provided in the upper flange portion. On an upper side of a back portion of both side walls 12, axis portions 15 for the lid are respectively projected on the same axial line. Also, on one of the side walls 12, an axis portion 16 for a piston damper is projected in an approximately central portion. Also, on the other of the side walls 12, a locking portion 17 retaining one end 4b of a turnover spring 4 as a biasing means, and a rib 18 corresponding to the turnover spring 4, are provided. The rib 18 is formed in a circular shape as a supporting point of the corresponding axis portion 15, and supports a winding portion 4a of the turnover spring 4 to be capable of inverting or swaying.

The lid 2 includes a plate portion 20 with an approximately short shape covering an opening on the main body side; supporting arms 21, 22 projecting on both sides of the plate portion 20; a holding portion (not shown in the figures) which is provided in an intermediate portion of right and left of a front margin and wherein fingers and the like are held at a time of manual rotating operation. In each arm 21 or 22, an attachment hole (not shown in the figures) corresponding to the axis portion 15 is provided on the same axial line. Also, on a lower portion of the arm 21, a connecting portion 21a is provided. The portion of the connecting portion 21a in the arm 21 has a thickness smaller than that of the other portion. An axial hole (not shown in the figures) is provided in the connecting portion 21a. On the other hand, on a lower end of the arm 22, a locking hole 22a is provided.

In the above-mentioned lid 2, the plate portion 20 is placed on an upper side of the main body 1. Also, the lid 2 is rotatably supported through a screw member 24, a washer 23, and the like relative to each axis portion 15 in a state wherein the arms 21, 22 on both sides are positioned and placed on the outside of the corresponding side walls 12 of the main body 1. Then, the lid 2 is changed over between the closed position blocking the opening on the upper side of the main body 1 and the open position opening the opening on the upper side.

(Rotating Mechanism)

A piston damper 3 which becomes a major portion of the rotating mechanism, and the turnover spring 4 as the biasing means are assembled between the main body 1 and the lid 2. Among them, one end 4b of the turnover spring 4 is retained in the locking portion 17 in a loosely fitted state, and the other end 4c is retained in the above-mentioned locking hole 22a while expressing the biasing force. In this attachment state, as shown in FIGS. 1(a), 1(b), the lid 2 is held in the closed position by the biasing force of the turnover spring 4.

For example, as shown in FIGS. 1(a), 1(b), the piston damper 3, including a cylinder 30 rotatably supported relative to the main body 1, and a piston rod 32 which appears and disappears from a central hole of a cap 31 installed in an opening portion of a cylinder of the cylinder 30, is preferably used. For the piston damper 3, heretofore known air dampers, which are disclosed in, for example, Japanese Utility Model Publication No. H07-7638, Japanese Unexamined Patent Publication No. 2006-90502, and the like, are preferably used. Specifically, the air damper with a type wherein the braking force acts only when the piston rod 32 is extended, is preferably used.

Also, the cylinder 30 includes a supporting portion 30a projected from an outer circumferential wall of a cylindrical shape whose bottom face is blocked, and an attachment hole (not shown in the figures) provided in the supporting portion 30a. A piston rod 31 includes a piston which is a braking mechanism portion (not shown in the figures) provided in an inner end, and a tongue-like connecting portion 32a provided in a projecting end. An inner end side of the piston rod 31 is received freely reciprocatingly inside the cylinder 30, and also a projecting end side is projected to the outside through the central hole of the cap 31 blocking an opening of the cylinder 30.

The above-mentioned piston damper 3 is rotatably and pivotally supported by locking a screw 25 and the like through the attachment hole of the supporting portion 30a in a state wherein the supporting portion 30a on a cylinder side is abutted against the axis portion 16 on a main body side wall. Also, the piston damper 3 is rotatably connected through a screw 33 and the like in a state wherein the connecting portion 32a on a piston rod side is overlaid relative to the connecting portion 21a on an arm side.

(Operation)

The above-mentioned rotating mechanism operates as follows at a time of opening and closing of the lid 2.

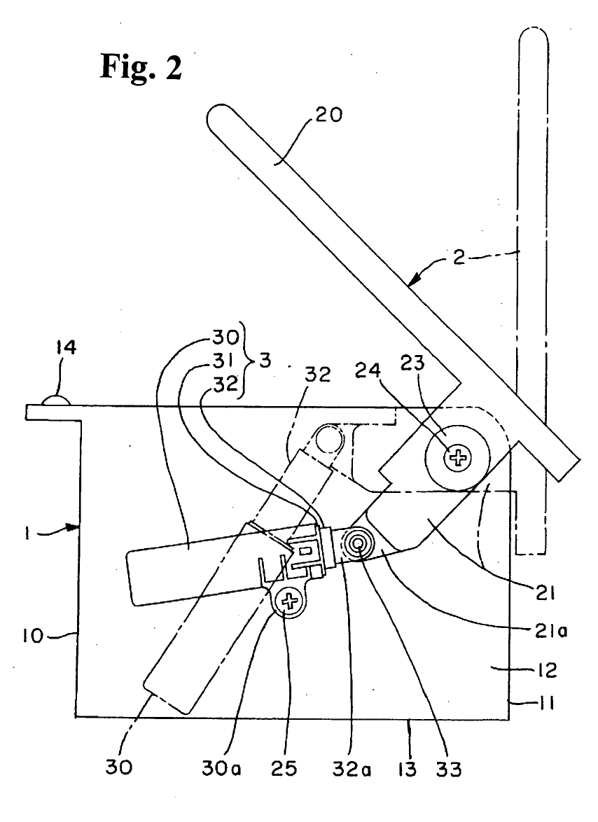

(A) When the lid 2 is changed over from the closed position to the open position (fully open position), the lid 2 is operated to rotate from the closed position shown in FIGS. 1(a), 1(b) up to a midway position shown in FIG. 2 with solid lines against the biasing force of the turnover spring 4 (i.e., while storing the biasing force), after passing through the midway position, the lid 2 is automatically rotated up to the open position in FIG. 3 by the biasing force of the turnover spring 4.

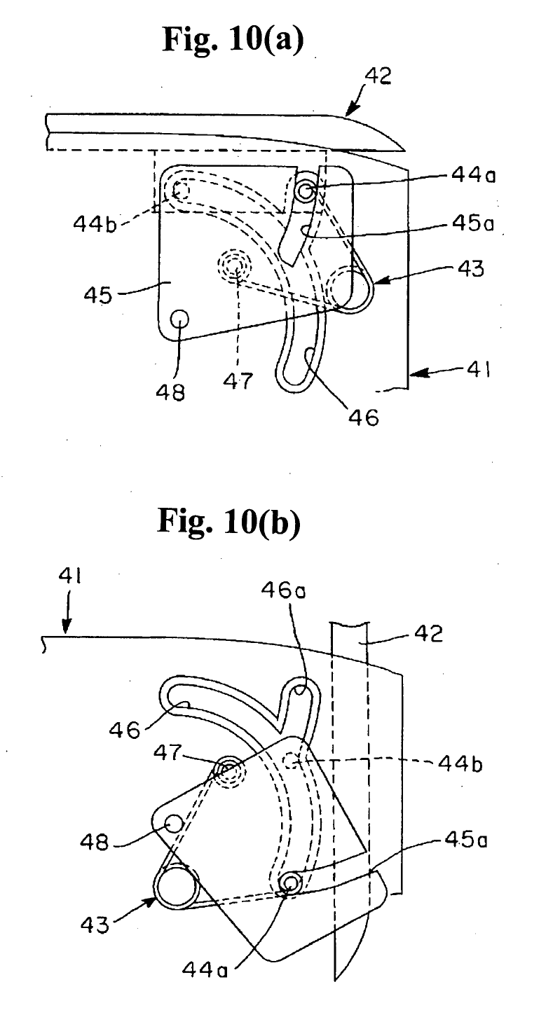

(B) When the lid 2 is changed over from the open position to the closed position, the lid 2 is operated to rotate from the open position in FIG. 3 up to the midway position shown in FIG. 2 with the solid lines against the biasing force of the turnover spring 4 (i.e., while storing the biasing force), and after passing through the midway position, the lid 2 is automatically rotated up to the closed position in FIGS. 1(a), 1(b) by the biasing force of the turnover spring 4. These lid changeover operations are the same as those of a conventional rotating mechanism shown in FIGS. 10(a), 10(b), or a rotating mechanism described in Patent Document 3. However, the lid changeover operations of the present invention are improved in that the following piston damper 3 is used.

(C) Specifically, in the piston damper 3, the cylinder 30 is rotatably and pivotally supported on a main body 1 side through the screw 25 and the like. Also, the piston rod 31 is rotatably connected relative to the arm 21 on a lid side through the screw 33 and the like, and the piston damper 3 changes over an extending/retracting direction thereof on the midway of each changeover operation from the closed position to the open position, and from the open position to the closed position of the lid 2. Specifically, in this first embodiment, a connecting portion (a portion connected through the screw 33 and the like) between the arm 21 and the piston rod 31 is set so as to traverse a straight line (a straight line S shown in FIG. 3) connecting each rotating center of the lid 2 and the piston damper 3 when the lid 2 is changed over from the closed position to the open position and from the open position to the closed position. Consequently, while using a one-way type which exerts the braking force only at the time of extending, the above-mentioned piston damper 3 operates as follows as the braking force.

(D) First, when the lid 2 is operated to rotate from the closed position in FIGS. 1(a), 1(b) up to the midway position (whose angle is approximately 45 degrees, and which corresponds to the straight line S in FIG. 3) in FIG. 2, the piston rod 31 retracts, so that the braking force does not act so as not to undermine the operability. After passing through the straight line S, the lid 2 is rotated up to the open position by the biasing force of the turnover spring 4. At this time, the piston rod 31 extends so as to exert the braking force, so that the piston damper 3 gently rotates the lid 2. Accordingly, the high quality of the rotating mechanism can be provided for an operator. Also, when the lid 2 is operated to rotate from the open position in FIG. 3 up to the midway position in FIG. 2, the piston rod 31 retracts, so that the braking force does not act so as not to undermine the operability. After passing through the above-mentioned straight line S, the lid 2 is rotated up to the closed position by the biasing force of the turnover spring 4. At this time, the piston rod 31 extends so as to exert the braking force, so that the piston damper 3 gently rotates the lid 2. Accordingly, the high quality of the rotating mechanism can be provided for an operator.

### Second Embodiment

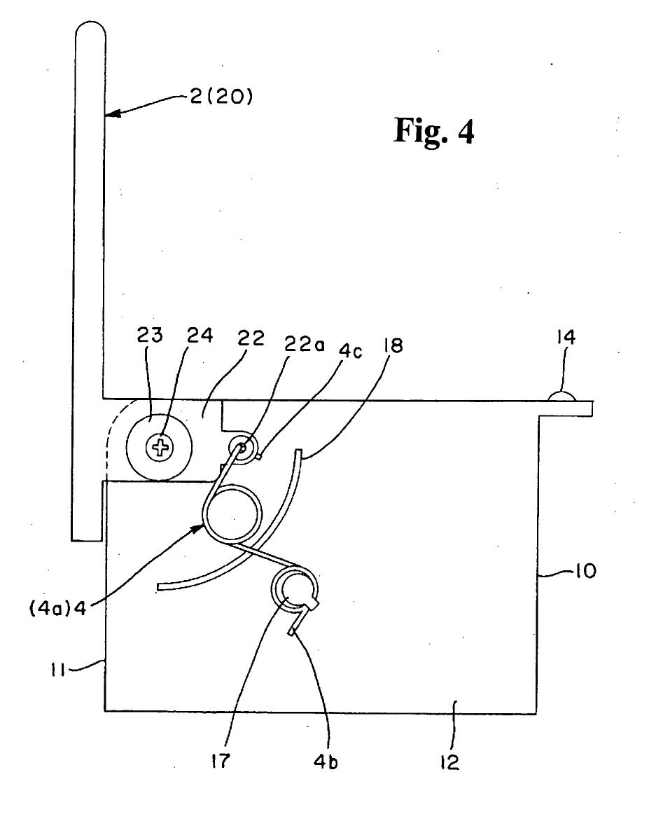

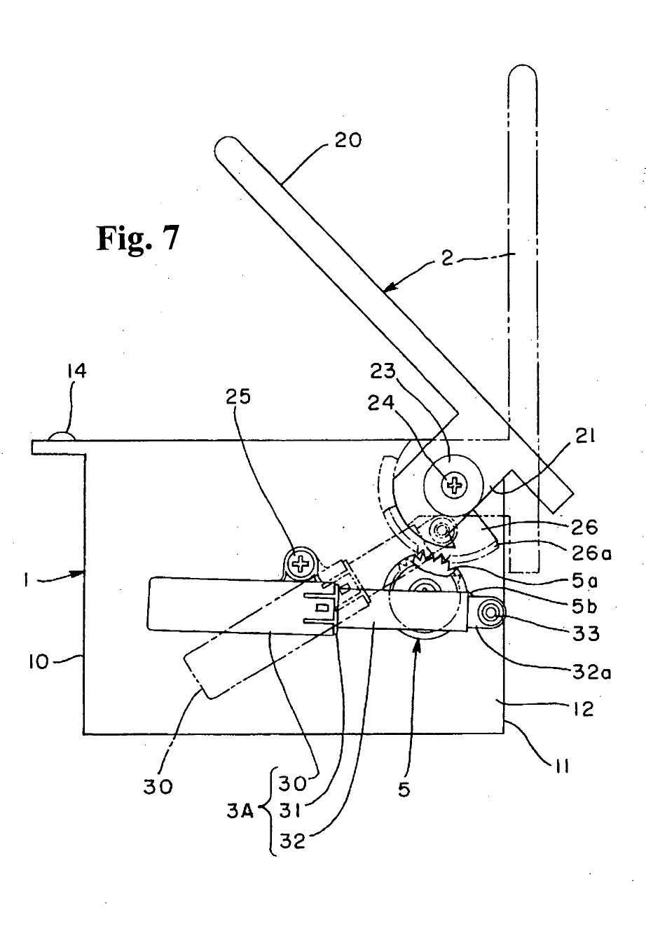

FIGS. 6(a), 6(b) are side views of both sides showing the second embodiment corresponding to FIGS. 1(a), 1(b). FIG. 7 is a side view showing the lid in FIGS. 6(a), 6(b) in a state of being operated to rotate up to the midway. FIG. 8 is a side view of the lid in FIG. 7 in a state of being changed over to the open position by the biasing force. Incidentally, FIGS. 6(a), 6(b) correspond to FIGS. 1(a), 1(b); FIG. 7 corresponds to FIG. 2; and FIG. 8 corresponds to FIG. 3. Also, FIG. 4 can be applied to even the second embodiment in a similar fashion. FIGS. 6(a) to 8 are an example connecting the arm on the lid side and the piston rod through a connecting member 5.

The connecting member 5 is formed in an approximately thick circular plate shape, and includes an axial hole (not shown in the figures) penetrated in a center of a circular plate; a gear 5a provided around the inside of the circular plate; and a connecting piece portion 5b projected from an outside portion of the circular plate. Then, this connecting member 5 is rotatably and pivotally supported relative to an axis portion (not shown in the figures) provided on the main body side wall 12 through a screw 28 and the like in a state of abutting against the axial hole of the center of the circular plate.

Also, on a lower end of the arm 21 on the lid side, in place of the connecting portion 21a of the first embodiment, a fan-like jutting portion 26 is integrally provided. This jutting portion 26 forms a gear portion 26 engaging with the gear 5a on a connecting member side on an outer circumference of a fan shape. Consequently, in this structure, if the connecting member 5 is attached to the main body side wall 12 through the screw 28 and the like, the gear 5a engages the gear portion 26.

Also, a piston damper 3A of the second embodiment is the same as the first embodiment in that the piston damper 3A includes the cylinder 30 rotatably supported relative to the main body 1 and the piston rod 32 which appears and disappears through the central hole of the cap 31 installed in the opening portion of the cylinder relative to the cylinder 30. However, the piston damper 3A is the type wherein the braking force acts only when the piston rod 32 retracts. One example for this is a structure wherein a valve of the piston provided on an inner end of the piston rod 32 is reversed as compared to the first embodiment as described in Japanese Utility Model Publication No. H07-7638.

The above-mentioned piston damper 3A is rotatably and pivotally supported on the main body side wall 12 through the screw 25 and the like in the same fashion as the first embodiment. Also, the connecting portion 32a on the piston rod side is rotatably connected relative to the connecting piece portion 5b on the connecting member side through the screw 33 and the like.

(Operations)

In the above-mentioned second embodiment, although operations of the above-mentioned (A) and (B) are the same, operations of (C) and (D) are as follows.

(C) Specifically, in the piston damper 3A, the cylinder 30 is rotatably and pivotally supported on the main body 1 side through the screw 25 and the like, and also the piston rod 31 is connected to the gear portion 26 of the arm 21 on the lid side through the gear 5a on the connecting member side. Accordingly, the extending/retracting direction thereof is changed over on the midway of each changeover operation from the closed position to the open position and from the open position to the closed position of the lid 2. Then, the above-mentioned piston damper 3A operates as follows as the braking force while using the one-way type exerting the braking force only at a time of retracting.

(D) First, when the lid 2 is operated to rotate up to the midway position (whose angle is approximately 45 degrees) in FIG. 7 from the closed position in FIGS. 6(a), 6(b), the piston rod 31 extends, so that the braking force does not act so as not to undermine the operability. After passing through the midway position in FIG. 7 in the same fashion as the first embodiment, the lid 2 is rotated up to the open position by the biasing force of the turnover spring 4. At this time, the piston rod 31 retracts so as to exert the braking force, so that the piston damper 3A gently rotates the lid 2. Accordingly, the high quality of the rotating mechanism can be provided for an operator. Also, when the lid 2 is operated to rotate up to the midway position in FIG. 2 from the open position in FIG. 8, the piston rod 31 extends, so that the braking force does not act so as not to undermine the operability. After passing through the midway position in FIG. 7, the lid 2 is rotated up to the closed position by the biasing force of the turnover spring 4 in the same fashion as the first embodiment. At this time, the piston rod 31 retracts so as to exert the braking force, so that the piston damper 3A gently rotates the lid 2. Accordingly, the high quality of the rotating mechanism can be provided for an operator. Also, in the second embodiment, the arm 21 on the lid side and the piston rod 31 on a piston damper side are connected through the engagement between a gear portion 26a on the arm side and the gear 5a on the connecting member side, so that a stroke of the piston damper 3A, i.e., an extending/retracting amount of the piston rod 31, can be changed so that degrees of freedom of design can be expanded.

### Third Embodiment

FIGS. 9(a), 9(b) are side views of both sides showing the third embodiment corresponding to FIGS. 1(a), 1(b). This third embodiment is an example wherein the piston damper 3 and the turnover spring 4 of the first embodiment is changed.

Specifically, in the third embodiment, each arm 21 provided on both sides of the lid 2 has the same shape, and is connected to a piston damper 38 which is rotatably and pivotally supported on each side wall 12 respectively with the same structure as the arm 21 and the piston damper 3 of the first embodiment. Consequently, in the third embodiment, the turnover spring 4 of the first embodiment is omitted, and alternatively, another piston damper 3B is added. However, in principle, only the piston damper 3B on one side may be provided. This is a case that, for example, the lid 2 is small, or that a large biasing force is not required for rotating the lid 2 since the lid 2 is light.

Each piston damper 3B is the same as the first embodiment in that the piston damper 3B includes the cylinder 30 rotatably supported relative to the main body 1, and the piston rod 32 which appears and disappears through the central hole of the cap 31 installed in the opening portion of the cylinder relative to the cylinder 30. Also, the piston damper 3B is the same as the first embodiment in that the braking force acts only when the piston rod 32 extends. The thing that is different is that the piston damper 3B includes a coil spring 36 which is embedded in the cylinder 30 and biases the piston rod 32 in a projecting direction. Incidentally, this damper structure is made by simplifying (omitting a cam and a latch) the structure disclosed in, for example, Japanese Unexamined Patent Publication No. H08-277873. Reference numerals 34 and 35 correspond to a circular connected portion and a lip seal described in Japanese Unexamined Patent Publication No. H08-277873.

Then, in this structure, the coil spring 36 embedded in the piston damper 3B operates as the biasing force in the same fashion as the turnover spring 4 of the first embodiment, so that the structure is simplified as compared to that of the first embodiment.

Incidentally, the present invention is not limited to the embodiments described hereinabove, and details can be variously modified as necessary. For example, in the first embodiment, when an increase of the biasing force is preferred, the piston damper 3B used in the third embodiment may be used in place of the piston damper 3.

The present application is based on Japanese Patent Application (Application No. 2008-13262) filed on Apr. 24, 2008, and contents thereof are incorporated herein as a reference.

### EXPLANATION OF SYMBOLS

1 . . . a main body (10 and 11 are front and back walls, and 12 is side walls)
2 . . . a lid (a movable body, 21 and 22 are arms)
3, 3A, 3B . . . a piston damper (damper means, 30 is a cylinder)
4 . . . a turnover spring (biasing means)
5 . . . a connecting member (5a is a gear, and 5b is a connecting piece portion)
36 . . . a coil spring (biasing means)

1. A rotating mechanism, comprising:
biasing means; and
damper means for braking,
wherein when a movable body is changed over from a first position to a second position and from the second position to the first position of a main body, the rotating mechanism operates to rotate the movable body against a biasing force of said biasing means up to midway of a changeover operation thereof, rotates the movable body by the biasing force of said biasing means after the midway, and brakes the movable body by said damper means in a predetermined interval in which the movable body is rotated by the biasing force, and
wherein said movable body includes an arm integrally rotated, and said damper means is a piston damper which is rotatably and pivotally supported on said main body, connected directly or indirectly relative to said arm, and provided so that an extending/retracting direction thereof is changed over on the midway of the changeover operation of said movable body.

2. A rotating mechanism according to claim 1, wherein said arm and said piston damper are rotatably connected.

3. A rotating mechanism according to claim 1, wherein said arm and said piston damper are connected through a connecting member rotatably and pivotally supported on said main body.

4. A rotating mechanism according to claim 1, wherein a connecting portion between said arm and said piston damper traverses a straight line connecting each rotational center of the movable body and said piston damper when said movable body is changed over from the first position to the second position and from the second position to the first position of said main body.

5. A rotating mechanism according to claim 1, wherein said piston damper operates a braking force on only one of an extending direction or a retracting direction.

6. A rotating mechanism according to claim 1, wherein said biasing means is a turnover spring which is sandwiched between said main body and said movable body.

7. A rotating mechanism according to claim 1, wherein said biasing means is a coil spring housed inside a cylinder of said piston damper.
